(19) United States
(12) Patent Application Publication
(10) Pub. No.: US 2002/0064278 A1
(43) Pub. Date: May 30, 2002

(54) High speed RSA public key cryptographic apparatus and method

(76) Inventors: Seongam Lim, Incheon (KR); Seungjoo Kim, Seoul (KR); Hongsub Lee, Seoul (KR)

Correspondence Address: Ajay A. Jagtiani, Jagtiani & Associates, Democracy Square Business Center, 10379-B Democracy Lane, Fairfax, VA, 22030, US

(21) Appl. No.: 09/796,695

(22) Filed: Mar. 2, 2001

(30) Foreign Application Priority Data
Nov. 30, 2000 (KR) 10-2000-0071859

(51) Int. Cl. H04K 1/00; H04L 9/00

(52) U.S. Cl. 380/30

(57) ABSTRACT

A method and apparatus are disclosed for improving RSA public key cryptographic scheme. The present invention discloses a cryptographic system with a modulus of the form n=p^{t}q^{s} where p and q are distinct prime numbers and t and s are distinct positive integers.

The present invention makes it possible to perform an encryption and decryption process in a high-speed manner even when the size of the modulus becomes huge for security.

### TECHNICAL FIELD

The present invention relates to a cryptographic system, and more particularly, to an RSA public key cryptographic apparatus and method with high-speed operating capability.

### BACKGROUND ART

Recent development of communication technology between computers enables netizens to communicate and interchange information through the network.

There are many applications, including electronic mail system, electronic commerce system, and banking system, where the transferred data should be securely transmitted and be read only by the authorized receiver.

An authentication system prevents the unauthorized injection of messages into an insecure channel, assuring the receiver of the message of the legitimacy of its sender.

The RSA (Ronald L. Rivest, Adi Shamir, and Leonard M. Adleman) system is one of the most popular public key cryptosystems. The RSA system, disclosed in U.S. Pat. No. 4,405,829, has proven to be an effective and convenient technique for enhancing data privacy and authentication.

In the RSA system, data to be secured, called plaintext, is transformed into encrypted data, or ciphertext, by a predetermined encryption process with a public key.

The reverse process, transforming ciphertext into plaintext with a private key, is termed decryption. The RSA scheme capitalizes on the relative ease of creating a composite number from the product of two prime numbers whereas the attempt to factor the composite number into its constituent primes is difficult.

The RSA scheme employs a public key E comprising a pair of positive integer n and e, where n is a composite number of the form

n=pq (1)

where p and q are different prime numbers, and e is a number relatively prime to (p−1) and (q−1).

For security concerns, the modulus size of today's RSA scheme is at least 1024 bits, which requires enormous computer resources to perform the encryption and decryption operations.

Further, the size of the modulus shall be increasing rapping due to the development of the factoring technology. The required enormous CPU time and increased storage capacity due to the increased size of the modulus will be a hurdle to implement an RSA scheme in a massive data processing system such as an electronic commercial transaction on internet.

In order to improve the efficiency for the implementation of the RSA scheme, several approaches have been proposed. One method, disclosed in U.S. Pat. No. 5,848,159, is to change the traditional form of modulus of the RSA scheme as the following.

n=P₁P₂P₃. . . Pᵤ, for u≧3 (2)

In the prior art disclosed in U.S. Pat. No. 5,848,159, the encryption process is the same as the conventional RSA scheme (U.S. Pat. No. 4,405,829) while the decryption is performed through the CRT (Chinese Remainder Theorem) in parallel computation made with u exponentiators.

The multi-prime technology disclosed in U.S. Pat. No. 5,848,159 relieves the computational complexity to some extent, and has recently been chosen to a WTLS (Wireless Transport Layer Security) protocol.

However, since the multi-prime technology disclosed in the prior art still employs the same decryption function as in the traditional RSA scheme, the computational burden increases in the order of (log P)³ with the number u of the prime numbers comprising the modulus when parallel computation modes are not allowed.

Furthermore, for the case of parallel computation modes, the number of the operators for multiple products increases with the number of the number u of the prime numbers even when parallel computational scheme is employed.

### DISCLOSURE OF THE INVENTION

In view of these problems, there is a need in the art for a cryptosystem that is not subject to these limitations.

Accordingly, it is an object of the present invention to provide an apparatus and method for high-speed processing during encryption and decryption of data without a loss of data security.

It is a further object of the present invention to provide an apparatus and method for high-speed processing during the modulus operation and multiple products for the RSA public key cryptographic scheme.

Yet it is another object of the present invention to provide an apparatus and method for high-speed encryption and decryption process even with security against electronic eavesdroppers.

In accordance with a broad aspect of the present invention, provided is an RSA public key cryptosystem with high-speed operating capability during encryption and decryption processes.

The present invention discloses a cryptosystem with a modulus of the form p^{t}q^{s}, more preferably of the form p^{r}q^{r+1}, r>1 when (t+s) is an odd number; p^{r-1}q^{r+1}, r>2 when (t+s)/2 is an even number; p^{r-2}q^{r+2}, r>3 when (t+s)/2 is an odder number.

As preferred embodiments in accordance with the invention, the modulus u can be chosen as pq², pq³ p²q³

### BRIEF DESCRIPTION OF THE DRAWINGS

Further features of the present invention will become apparent from a description of an RSA public key criptosystem, taken in conjunction with the accompanying drawings of the preferred embodiment of the invention, which, however, should not be taken to be limitative to the invention, but are for explanation and understanding only.

In the drawings:

FIG. 1 is a schematic diagram illustrating a process for generating a public key and a private key in accordance with a preferred embodiment of the present invention.

FIG. 2 is a schematic diagram illustrating a process for decrypting the ciphertext into the plaintext in accordance with a preferred embodiment of the present invention.

FIG. 3 is a schematic diagram illustrating a communication system with a cryptography in accordance with a preferred embodiment of the present invention.

FIG. 4 is a schematic table illustrating the features of the present invention with comparison to the prior arts.

### BEST MODE FOR CARRYING OUT THE INVENTION

The present invention will be explained in detail with reference to the accompanying drawings.

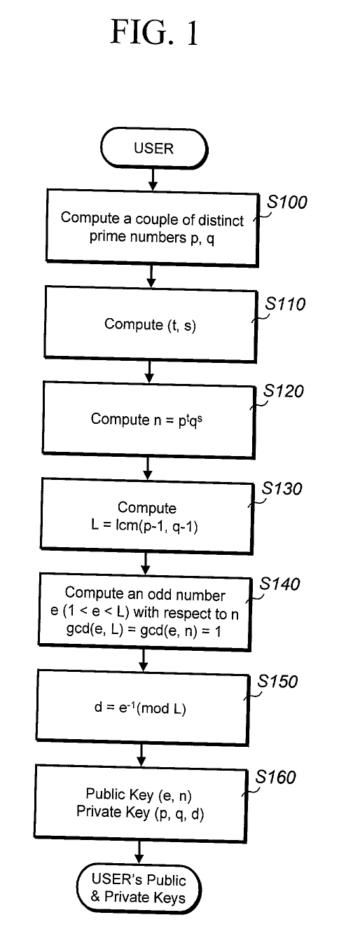

FIG. 1 is a schematic diagram illustrating a process for generating a public key and a private key in accordance with a preferred embodiment of the present invention.

Referring to FIG. 1, a couple of large primes p and q are randomly chosen (step S100).

n=p^{t}q^{s} (3)

Thereafter, (t,s) is computed in accordance with a preferred embodiment of the present invention (step S110) Namely, (t,s)=(r,r+1), r>1 when (t+s) is an odd number; (t,s)=(r−1,r+1), r>2 when (t+s)/2 is an even number; and (t,s)=(r−2,r+2), r>3 when (t+s)/2 is an odd number.

As preferred embodiments in accordance with the present invention, the modulus n can be of the form, n=pq², pq³, p²q³ Now, the modulus of the cryptosystem n=p^{t}q^{s} can be computed (step S120).

The criptosystem in accordance with the present invention obtains its security from the difficulty of factoring large numbers, and its high-speed operating capability from the form of the modulus, n=p^{t}q^{s}.

Referring to FIG. 1 again, the LCM Value L of (p−1) and (q−1) is then calculated (step S130). Thereafter, an odd integer, e, is chosen such that 1<e<L, and gcd (e,L)=gcd (e,n)=1 (step S140).

Finally the decryption key, d, is established by the relationship (step S150):

d=e⁻¹(mod L)

Now, we publish e and n as the public keys and keep d, p, q as private keys (step S160).

In the meanwhile, the mapping E,

E:Z^{*}ₙ→Z^{*}ₙ by E(m)=m^{e}(mod n) for m εZ^{*}ₙ (4)

becomes a one-to-one permutation on Z^{*}ₙ. For the modulus of the form n=p^{t}q^{s} in accordance with the present invention, the choice of e in the invention gives a one-to-one permutation on Z^{*}ₙ.

The choice of p, q, e, and d allows the user to employ even the shorter keys with keeping the same modulus size when compared with the scheme of the prior art such as the conventional RSA approach disclosed in U.S. Pat. No. 4,405,829.

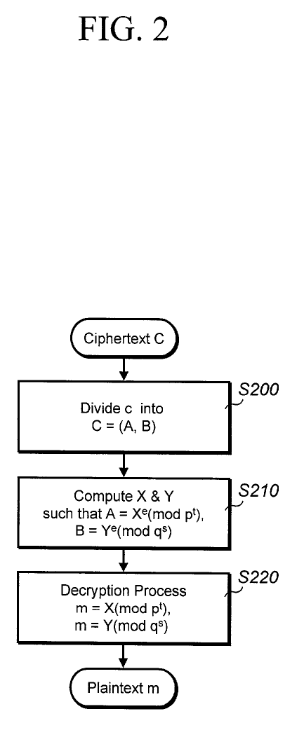

FIG. 2 is a schematic diagram illustrating a process for decrypting the ciphertext into the plaintext in accordance with a preferred embodiment of the present invention.

Referring to FIG. 2, the decryption process relies on the p-adic expansion for elements in Z^{*}ₚ_{^{t}} and q-adic expansion for elements in Z^{*}_{q}_{^{s}}. Since p and q are distinct primes, we have the following relationship by Chinese Remainder Theorem.

Z^{*}ₙ≅Z^{*}ₚ×Z^{*}ₚ (5)

When a ciphertext, C, in Z^{*}ₙ is received, C can be split into:

C=(A,B), AεZ^{*}ₚ_{^{t}} and BεZ^{*}_{q}_{^{s}} (6)

Since C is a ciphertext, C can be written as C=m^{e}(mod n) for some mεZ^{*}ₙ. Similarly, m can be split into two parts, XεZ^{*}ₚ_{^{p}} and YεZ^{*}_{q}_{^{s}}.

As a consequence, A=X^{e}(mod p^{t}) and B=Y^{e}(mod q^{s}) Since XεZ^{*}ₚ_{^{t}}, X can be represented as:

X=X₀pX₁+p²X₂+. . . +p^{t-1}Xᵣ₋₁(mod p^{t}) (7)

for some X₁εZ^{*}ₚ_{^{t}} with 0≦i≦r−1. Similarly, YεZ^{*}_{q}_{^{s}} can be represented as:

Y=Y₀+qY₁+q²Y₂+. . . +q^{s-1}Yₛ₋₁(mod q^{s}) (8)

for some YᵢεZ^{*}_{q}_{^{s}} with 0≦i>s−1.

Now, suppose AεZ^{*}ₚ_{^{t}} is written by:

A=A₀+pA₁+p²A₂+. . . +p^{t-1}Aₜ₋₁(mod p^{t}) (9)

for 1≦i≦t−1, we set:

A[i]=A₀+pA₁+. . . +pⁱAᵢ

=(X₀+pX₁+. . . +pⁱXᵢ)^{e}(mod pⁱ⁺¹)

F[i]=(X₀+pX₁+. . . +pᵢ₋₁Xᵢ₋₁)^{e} (10)

Then we note that Fₜ(mod p^{t})=A and A[t−1]=A. We also note the following relationship:

A[i]=A₀+pA₁+. . . +pⁱAᵢ(mod pⁱ⁺¹)

=(X₀+pX₁+. . . +p¹Xᵢ)^{e}(mod pⁱ⁺¹)

=(X₀+pX₁+. . . +pⁱ⁻¹Xᵢ₋₁)^{e}+eX₀^{e-1}pⁱXᵢ(mod pⁱ⁺¹)

=Fᵢ+eX₀^{e-1}pⁱXᵢ(mod pⁱ⁺¹) (12)

Finally, we come to the following relationship:

Xₒ=A₀^{d(mod p-1)}(mod p)

eX₀^{e-1}Xᵢ=[Aᵢ−Fᵢ(mod pⁱ⁺¹)]/pⁱ(mod p), i=1, 2, . . . , t−1 (14)

From equations (13) and (14), we can calculate X₀, X₁, X₂, . . . , Xₜ₋₁ by iteration from i=0 to i=t−1.

Thereafter, X=X₀+X₁p+. . . +xₜ₋₁p^{t-1} can be computed (step S210). In a similar manner, Y can be computed (step S210) from the relationship:

Gⱼ=(Y₀+Y₁q+. . . +Yⱼ₋₁q^{j-1})^{e} (15)

Y₀=B₀^{d(mod q-1)}(mod q) (16)

eY₀^{e-1}Yⱼ=[Bⱼ−Gⱼ(_{mod q}^{j+1})]/q^{j}mod q, j=1, 2, . . . , s−1 (17)

Now we can recover the plaintext, m, from the computed X and Y from the relationship:

m={(X−Y mod q^{s})q^{-s}mod p^{t}}q^{s}+Y mod n (18)

Where q^{-s}εZ^{*}ₚ_{^{t}} that satisfies q^{s}q^{-s}=1 mod p^{t}.

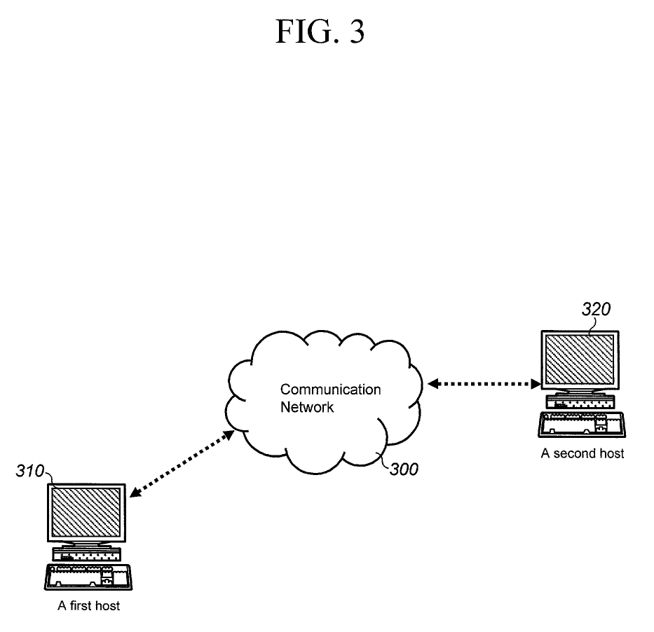

FIG. 3 is a schematic diagram illustrating a communication system with a cryptography in accordance with a preferred embodiment of the present invention.

Referring to FIG. 3, a couple of terminals (i=A, B) are depicted for illustration despite the fact that the network can comprise arbitrarily as many terminals as possible.

A plaintext is encrypted at a first terminal 310 and transferred to a second terminal 320 where the ciphertext is decrypted.

At an arbitrary terminal with an index of i (i=1, 2, , j), the modulus mᵢ is generated with the relationship nᵢ=pᵢ^{t}qᵢ^{s} for distinct primes, t and s, in order to encrypt the message, mᵢ.

Thereafter, the LCM value, Lᵢ, of (pᵢ−1) and (qᵢ−1) is computed and an odd integer, eᵢ, is chosen such that 1<eᵢ<Lᵢ, and gcd (eᵢ,Lᵢ)=gcd (eᵢ, nᵢ)=1.

Finally, we have a public key comprising (nᵢ,eᵢ) and a private key comprising (pᵢ,qᵢ,dᵢ). Now the plaintext, m_{A}, to be transmitted to a to second terminal 320 is encrypted with a constraint 0<ₘ_{_{A}}<ₙ_{_{B}}−1 and _{C}_{_{A}}=ₘ_{_{A}}^{e}^{ₚ} (mod ₙ_{_{B}}) at a first terminal 310.

In the above explanations, subscript A denotes sending terminal while B denotes receiving terminal.

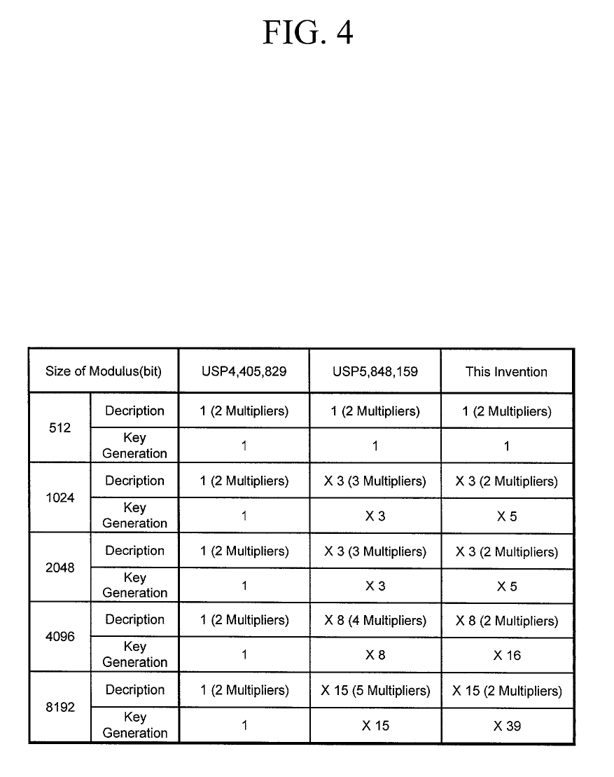

FIG. 4 is a schematic table illustrating the features of the present invention with comparison to the prior arts.

Referring to FIG. 4, it can be noted that as the size of the modulus is increased from 512 bits to 8192 bits, for instance, the computational efficiency has been improved by 39 times when compared with the prior arts.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A method for cryptographic communications comprising the steps of:
encoding a plaintext message, m, to a ciphertext, C, where m corresponds to a number representative of a message and 0≦m≦n−, n being a composite number formed from the product of p^{t}q^{s} where t and s are prime numbers;
computing an LCM value, L, of (p−1) and (q−1) and then selecting an odd integer, e, such that 1<e<L, and gcd (e,L)=gcd (e,n)=1;
generating a public key (n,e) and a private key (p,q,d) where d=e⁻¹ mod L; and
transforming said plaintext, m, into said ciphertext, C whereby C=m^{e}(mod n) where mεZ^{*}ₙ.

2. The method as set forth in claim 1 wherein said t and s comprise a set of numbers:
(t,s)=(r,r+1), r>1 when (t+s) is an odd number;
(t,s)=(r−1,r+1), r>2 when (t+s)/2 is an even number; and
(t,s)=(r−2,r+2), r>3 when (t+s)/2 is an odd number where r is an integer.

3. The method as set forth in claim 1, further comprising the steps of:
separating said ciphertext, C, into A and B, C=(A,B) such that
A=C(mod p^{t})εZ^{*}ₚ_{^{t}} and
B=C(mod q^{s})εZ^{*}_{q}_{^{s}};
expanding said separated ciphertext A and B with coefficients Aᵢ and Bᵢ such that
A=A₀+A₁p+A₂p²+. . . +Aₜ₋₁p^{t-1} and
B=B₀+B₁q+B₂q²+. . . +Bₛ₋₁q^{s-1} whereby
AᵢεZ^{*}ₚ_{^{t}} and BᵢεZ^{*}_{q}_{^{s}};
computing X₀, X₁, Xₜ₋₁ interactively from i=0 to i=t−1 from the relationships of
Fᵢ(X₀+X₁p+X₂p²+. . . +Xᵢ₋₁pⁱ⁻¹)^{e},
X₀=A₀^{d(mod p-1)}(mod p)
eX₀^{e-1}Xᵢ=[Aᵢ−Fᵢ(mod pⁱ⁺¹)]/pⁱ(mod p)
and storing the calculated value of X from the relationship of
X=X₀+X₁p+. . . +Xₜ₋₁p^{t-1};
computing Y₀, Y₁, . . . , Yₛ₋₁ interactively from j=0 to j=s−1 from the relationships of
Gⱼ=(Y₀+Y₁q+. . . +Yⱼ₋₁q^{j-1})^{e},
Y₀=B₀^{d(mod q-1)}(mod q)
eY₀^{e-1}Yⱼ=[Bⱼ−Gⱼ(mod q^{j-1})]/q^{j}(mod q)
and storing the calculated value of Y from the relationship of
Y=Y₀+Y₁q+. . . +Yₛ₋₁q^{s-1}; and
decrypting said ciphertext, C, into said plaintext, m, from the relationship of
m={(X−Y mod q^{s})q^{-s}mod p^{t}}q^{s}+Y mod n.

4. A method for transferring a message, mᵢ, in a communication system having j terminals, wherein each terminal is characterized by an encoding key Eᵢ=(eᵢ,nᵢ) and decoding key Dᵢ=(pᵢ, qᵢ, dᵢ) where i=1, 2, , j, and wherein m₁ corresponds to a number representative of a message to be transmitted from the i-th terminal, nᵢ is a composite number of the form
nᵢ=pᵢ^{t}qᵢ^{s}
where pᵢ and qᵢ are distinct prime numbers, and t and s are distinct positive integers, comprising the steps of:
encoding a message m_{A} for transmission from a first terminal (i=A) to a second terminal (i=B), said encoding step including the sub-steps of;
computing an LCM value, L_{B}, of (p_{B}−1) and (q_{B}−1) and then selecting an odd integer, e_{B}, such that 1<e_{B}<L_{B}, and gcd (e_{B},L_{B})=gcd(e_{B},n_{B})=1;
generating said encoding key E_{B}=(n_{B},e_{B}) and said decoding key D_{B}=(p_{B},q_{B},dB) where d_{B}=e_{B}⁻¹mod L_{B}; and
transforming said plaintext, m_{A}, into said ciphertext, C_{A} whereby
_{C}_{_{A}}=ₘ_{_{A}}^{e}^{_{B}}(mod ₙ_{_{B}}) for 0≦m_{A}>n_{B}−1.

5. The method as set forth in claim 4 wherein said t and s comprises a set of numbers:
(t,s)=(r,r+1), r>1 when (t+s) is an odd number;
(t,s)=(r−1,r+1), r>2 when (t+s)/2 is an even number; and
(t,s)=(r−2,r+2), r>3 when (t+s)/2 is an odd number where r is an integer.

6. A cryptographic communication system comprising:
an encoding means wherein a couple of distinct prime numbers, p and q, are generated and a modulus, n, is computed such that n=p^{t}q^{s} where t and s are distinct positive integers, while an LCM value, L, of (p−1) and (q−1) is computed and an odd integer, e, is selected such that 1<e<L, and gcd (e,L)=gcd (e,n)=1, thereby generating a public key (n,e) and a private key (p,q,d) where d=e⁻¹ mod L;
a multiplier performing an operation for encrypting said plaintext, m, into said ciphertext, C such that
C=m^{e}(mod n) for mεZ^{*}ₙ; and
a decoding means wherein said ciphertext is separated into two parts, A and B, and then A and B are computed from the relationships of
A=X^{e}(mod p^{t}), B=Y^{e} (mod q^{s}) whereby XεZ^{*}ₚ_{^{t}}, YεZ^{*}_{q}_{^{s}}.

7. The cryptographic communication system as set forth in claim 6 wherein said t and s comprise a set of numbers:
(t,s)=(r,r+1), r>1 when (t+s) is an odd number;
(t, s)=(r−1, r+1), r>2 when (t+s)/2 is an even number; and
(t,s)=(r−2,r+2), r>3 when (t+s)/2 is an odd number where r is an integer.

8. The cryptographic communication system as set forth in claim 6 wherein said decoding means carries out the operation of:
expanding said separated ciphertext A and B with coefficients Aᵢ and Bᵢ such that
A=A₀+A₁p+A₂p²+. . . +Aₜ₋₁p^{t-1} and
B=B₀+B₁q+B₂q²+. . . +Bₛ₋₁qₛ₋₁ whereby
AᵢεZ^{*}ₚ_{^{t}} and BᵢεZ^{*}_{q}_{^{s}};
computing X₀, X₁, Xₜ₋₁ interactively from i=0 to i=t−1 from the relationships of
F₁=(X₀+X₀p+X₂p²+. . . +Xᵢ₋₁Pⁱ⁻¹)^{e},
X₀=A₀^{d(mod p-1)}(mod p)
eX₀^{e-1}Xᵢ=[Aᵢ−Fᵢ(mod pⁱ⁺¹)]/pⁱ(mod p)
and storing the calculated value of X from the relationship of
X=X₀+X₁p+. . . +Xₜ₋₁p^{t-1};
computing Y₀, Y₁, Yₛ₋₁ interactively from j=0 to j=s−1 from the relationships of
Gⱼ=(Y₀+Y₁q+. . . +Yⱼ₋₁p^{j-1})^{e},
Y₀=B₀^{d(mod p-1)}(mod q),
eY₀^{e-1}Yⱼ=[Bⱼ−Gⱼ(mod q^{j+1})]/q^{j}(mod q)
and storing the calculated value of Y from the relationship of
Y=Y₀+Y₁q+. . . +Yₛ₋₁q^{s-1}; and
decrypting said ciphertext, C, into said plaintext, m, from the relationship of
m={(X−Y mod q^{s})q^{-s}mod p^{t}}q^{s}+Y mod n.
